(19) United States
(12) Patent Application Publication
(10) Pub. No.: US 2011/0218719 A1
(43) Pub. Date: Sep. 8, 2011

(54) POWERTRAIN OF A VEHICLE AND A METHOD OF OPERATING A POWERTRAIN OF A VEHICLE FOR CLUTCH PROTECTION

(75) Inventor: Eckhard KIRCHNER, Ginsheim (DE)

(73) Assignee: GM GLOBAL TECHNOLOGY OPERATIONS LLC, Detroit, MI (US)

(21) Appl. No.: 13/037,636

(22) Filed: Mar. 1, 2011

(30) Foreign Application Priority Data
Mar. 2, 2010 (GB) 1003438.7

(51) Int. Cl. B60W 10/02; B60W 30/18; B60W 10/04; B60W 10/10

(52) U.S. Cl. 701/53

(57) ABSTRACT

A powertrain of a vehicle includes, but is not limited to a prime drive coupleable to a multi-speed transmission by actuation of one or more clutches and a system for operating the powertrain for clutch protection. The system includes, but is not limited to an estimator for estimating the thermal load on the clutch from drive resistance of the vehicle and the torque deliverable by the prime drive at a sensed position of the throttle and an apparatus for increasing the torque delivered by the prime drive to above the estimated torque at the sensed position of the throttle to reduce the thermal load on the clutch if the estimated thermal load on the clutch is higher than the predetermined threshold.

### CROSS-REFERENCE TO RELATED APPLICATION

This application claims priority to British Patent Application No. 1003438.7, filed Mar. 2, 2010, which is incorporated herein by reference in its entirety.

### TECHNICAL FIELD

The technical field relates to a powertrain of a vehicle and a method of operating a powertrain of a vehicle for clutch protection.

### BACKGROUND

A vehicle such as a road passenger vehicle includes a powertrain comprising a prime drive, such as an internal combustion engine, for propelling the vehicle and a multi-speed transmission. The prime drive is coupled to the multi-speed transmission by one or more clutches so that torque can transferred from the prime drive to the multi-speed transmission and the final drive in order to move the vehicle. The clutch may be a normally-closed clutch, as is typically the case for manually operated transmissions, or a normally-open clutch as is typically the case for dual clutch transmissions (DCT).

When a driver wishes to launch a vehicle with a manual transmission, he releases the clutch pedal, closing a spring system which clamps the clutch disk. If the driver releases the clutch pedal very slowly, he may cause sufficient slip on the clutch disc to thermally overload the clutch lining and ruin the clutch.

Excessive clutch slip and thermal overload may also occur if the driver attempts to launch the vehicle with too little engine torque, since a low engine torque results in an increased clutch slip time and increased heat generation in the clutch lining. This situation may occur when the vehicle is positioned on an upwardly inclined surface and/or has an increased weight as it is towing a trailer or is otherwise carrying a heavy load.

U.S. Pat. No. 7,314,429 discloses a method for the advance determination of an overload of an automatically actuated clutch of a vehicle during the slippage phase to prevent overload. The energy introduced into the clutch during a predetermined first time span of the slippage phase and, on the basis of the anticipated energy introduction into the clutch and/or the anticipated clutch temperature, measures are taken to prevent overload.

However, methods for preventing thermal overload of the clutch in manual transmissions and dual clutch transmissions are also desirable. In addition, other desirable features and characteristics will become apparent from the subsequent summary and detailed description, and the appended claims, taken in conjunction with the accompanying drawings and this background.

### SUMMARY

A method of operating a powertrain of a vehicle is provided for clutch protection comprising: estimating the drive resistance of the vehicle; sensing the position of a throttle of the prime drive; estimating the torque deliverable by the prime drive at the sensed position of the throttle; estimating the thermal load on the clutch using the estimated drive resistance of the vehicle and the estimated torque deliverable by the prime drive, and comparing the estimated thermal load on the clutch with a predetermined threshold. If the estimated thermal load on the clutch is lower than the predetermined threshold, the vehicle is allowed to launch. If the estimated thermal load on the clutch is higher than the predetermined threshold, the torque delivered by the prime drive is increased above the estimated torque at the sensed position of the throttle to reduce the thermal load on the clutch upon launch of the vehicle. Afterwards, the vehicle is allowed to launch.

The powertrain of the vehicle comprises a prime drive coupleable to a multi-speed transmission by actuation of one or more clutches. The multi-speed transmission may be a manual transmission or a dual clutch transmission (DCT).

The sensed position of the throttle may correspond to that commanded by the driver by the driver depressing the accelerator pedal in the vehicle. The method of operating the powertrain provides clutch protection by increasing the torque delivered by the prime drive above the predicted value of the torque which would be delivered by the engine based on the sensed position of the throttle and allows the vehicle to launch at this torque value in order to reduce clutch slip, the generation of heat due to friction and the thermal load on the clutch. The method overrides the drivers command if the commanded value of the torque is predicted to thermally overload the clutch.

This method may be used when the vehicle is positioned on an upwardly inclined slope, for example. If the driver underestimates the torque required to launch the vehicle optimally and depresses the accelerator pedal too lightly, he asks the prime drive to deliver a value of torque to the clutch which would result in sufficient clutch slippage that the thermal load on the clutch would be higher than the predetermined threshold. In this case, the torque delivered by the engine is increased above the commanded value of the torque, to reduce the slip time and reduce the thermal load on the clutch. The command of the driver is overridden so as to protect the clutch. If, however, the driver requests the prime drive to deliver a value of torque to the clutch which results in the clutch slippage causing a thermal load on the clutch that is lower than the predetermined threshold, the vehicle is launched with the value of the torque requested by the driver.

In an embodiment, the torque delivered by the prime drive upon launch of the vehicle is increased by an amount sufficient that the thermal load on the clutch is reduced to below the predetermined threshold. This increases the protection of the clutch.

In further embodiment, a driver warning is actuated if the torque delivered by the prime drive is increased above estimated torque at the sensed position of the throttle. The driver warning may be a light on the vehicle control panel, for example. A driver warning tells the driver that the vehicle will behave differently to the commanded behaviour since the system has overridden the drivers command so that the vehicle will launch with a higher torque than that commanded by the driver.

The torque may be increased above the estimated torque at the sensed position of the throttle by further opening the throttle. If the throttle is operated by an engine control unit, that is there is no direct mechanical connection between the accelerator pedal and throttle, and the engine control unit can also be used in the method to increase the torque above the estimated torque at the sensed position of the throttle by adjusting the position of the throttle to deliver the total torque value required to protect the clutch. The total torque value delivered to the clutch is the sum of the estimated torque deliverable by the prime drive at the sensed position of the throttle and the additional torque required to reduce the thermal load on the clutch upon launch of the vehicle as determined by the method. The method estimates the thermal load on the clutch using the estimated drive resistance of the vehicle and the estimated torque deliverable by the prime drive at the sensed position of the throttle.

The drive resistance of the vehicle may be estimated using one or more of the group of parameters consisting of combined gross vehicle weight (CGVW), rolling resistance, gradient resistance, air/wind resistance and acceleration resistance. The combined gross vehicle weight may be measured by using sensors coupled to the vehicle. Sensors may be useful for vehicles in which the weight very significantly, such as trucks and vehicles which optionally tow trailers. Alternatively, the combined gross vehicle weight may be estimated from the fixed weight of the empty vehicle and an expected additional load.

The thermal load on the clutch may be estimated using a thermal model of the clutch that uses one or more of the group of parameters consisting of thermal mass of the clutch, convection of the heat generated within the clutch away from the clutch, estimated clutch slip and clutch friction which generates heat in the clutch and gear ratio. For example, the vehicle may launch in either first gear or reverse gear which may have different gear ratios and, therefore, require different values of torque to reduce the thermal load to below the predetermined threshold on clutch upon launch of the vehicle in either first gear or reverse gear.

In a further embodiment, the history of the thermal load on the clutch is taken into account when estimating the anticipated thermal load on the clutch for the value of the estimated torque deliverable by the prime drive at the sensed position of the throttle. The history of the thermal load of on the clutch may be taken into account by storing the estimated thermal load on the clutch that has occurred within a predetermined previous time interval, for example, in the previous 15 minutes. This embodiment may be used in stop and go situations in which the vehicle is launched from stationary repeatedly.

In a further embodiment, the total torque to be delivered to the clutch is determined and the expected clutch slip time interval for this total torque is determined. The clutch slip time may then be reduced compared to the expected clutch slip time interval by closing or opening the clutch, depending on whether the clutch is normally-closed or normally open. This embodiment may be used when the expected clutch slip time interval for the total torque would still be undesirably long and undesirably increase the thermal load on the clutch. This may occur under extreme conditions in which the total torque which would have to be delivered to the clutch in order to reduce the thermal load on the clutch to below the predetermined threshold would be undesirably high. Therefore, the clutch may be protected, partially, by increasing the total torque to reduce the clutch slip time interval and, partially, by further, actively, reducing the clutch slip time by opening or closing the clutch.

In a further embodiment, the method first determines if the vehicle is in a launch condition and, if the vehicle is in the launch condition, the method of one of the previous embodiments is carried out. The launch condition of the vehicle may be determined using one or more of the group of parameters consisting of engagement of a gear ratio, for example first gear or reverse gear, vehicle speed, a sensed open throttle position, sensed engine idling and sensed clutch position. For example, if first gear is engaged, the clutch disengaged, the vehicle stationery, the engine idling and the throttle is slightly open, this may be taken as an indication that the driver intends to launch the vehicle.

A computer program product is also provided that comprises a computer executable code for carrying out the method of one of the previously described embodiments. The computer program may be stored and executed by one or both of the engine control unit and the transmission control unit. For a manual transmission, code for the drive resistance estimation, the estimation of the engine torque and the estimation of the thermal load on the clutch may be stored and/or executed by the engine control unit. For a dual clutch transmission, code for the estimation of the engine torque may be stored and/or executed by the engine control unit and code for the estimation of the drive resistance and the thermal load on the clutch may be stored and/or executed by the transmission control unit.

A powertrain is provided for vehicle that comprises a prime drive, such as an internal combustion engine, coupleable to a multi-speed transmission by actuation of one or more clutches. The one or more clutches may be normally-open or normally-closed dry clutches. The powertrain also comprises a system for operating the powertrain for clutch protection. The system comprises means for estimating the drive resistance of the vehicle, means for sensing the position of a throttle of the prime drive, means for estimating the torque deliverable by the prime drive at the sensed position of the throttle, means for estimating the thermal load on the clutch from the drive resistance of the vehicle and the torque deliverable by the prime drive, means for comparing the estimated thermal load on the clutch with a predetermined threshold and means for increasing the torque delivered by the prime drive above the estimated torque at the sensed position of the throttle to reduce the thermal load on the clutch upon launch of the vehicle if the estimated thermal load on the clutch is higher than the predetermined threshold.

For a manual transmission, the means for estimating the drive resistance, the engine torque and the thermal load on the clutch may be the engine control unit. For a dual clutch transmission, the means for estimating the engine torque at the sensed throttle position may be the engine control unit and the means for estimating the drive resistance and the thermal load on the clutch may be the transmission control unit.

The powertrain may also include a throttle position sensor to sense the position of the throttle of the prime drive. The throttle sensor may be used by the system to determine the torque deliverable to the transmission corresponding to a command of the driver. The engine control unit may be used to adjust the position of the throttle to increase the torque delivered by the prime drive above the estimated torque at the sensed position of the throttle to reduce the thermal load on the clutch if the anticipated thermal load on the clutch is predicted to be higher than the predetermined threshold.

A vehicle is provided that includes the powertrain according to one of the previously described embodiments.

### BRIEF DESCRIPTION OF THE DRAWINGS

The present invention will hereinafter be described in conjunction with the following drawing figures, wherein like numerals denote like elements, and

FIG. 1 illustrates a schematic diagram of a system for operating a powertrain with a manual transmission for a clutch protection;

FIG. 2 illustrates a schematic diagram of a system for operating a powertrain with a dual clutch transmission for clutch protection;

FIG. 3 illustrates a schematic diagram of a dual clutch transmission;

FIG. 4 illustrates the estimation of the drive resistance of a vehicle;

FIG. 5 illustrates a graph of torque against combined gross vehicle weight; and

FIG. 6 illustrates a flow chart of a method for operating the powertrain of a vehicle for clutch protection.

### DETAILED DESCRIPTION

The following detailed description is merely exemplary in nature and is not intended to limit application and uses. Furthermore, there is no intention to be bound by any theory presented in the preceding background or summary or the following detailed description.

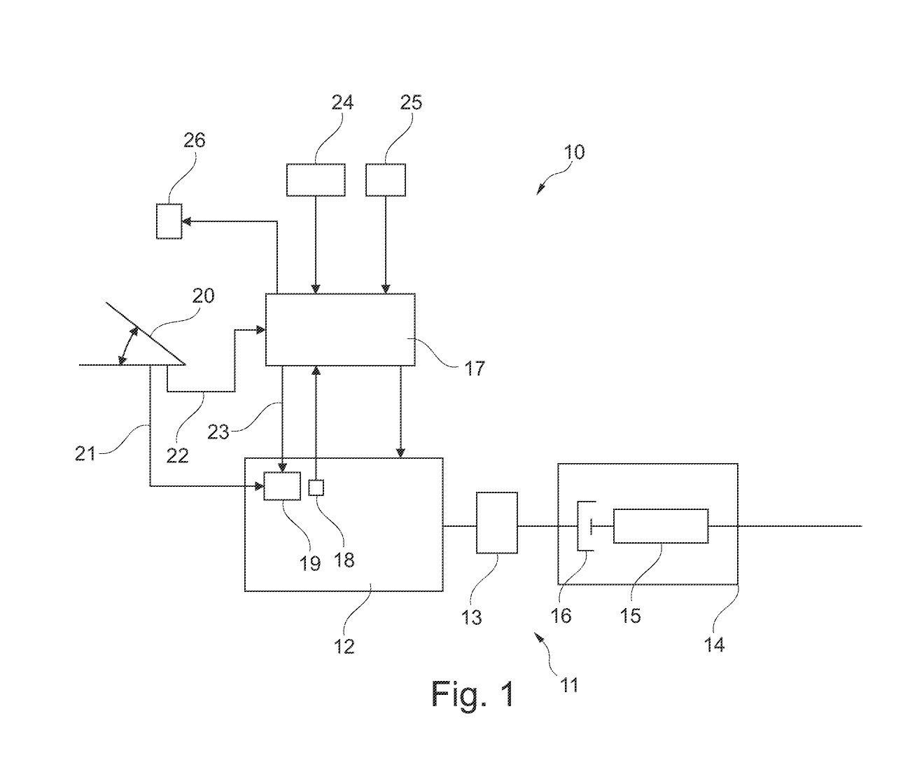

FIG. 1 illustrates a system 10 for operating a powertrain 11 of a non-illustrated vehicle for clutch protection. The powertrain 11 includes an internal combustion engine 12, a clutch 13 and a manual transmission 14. The engine 12 can be coupled to, and decoupled from, the manual transmission 14 by actuation of the clutch 13. The clutch 13 is a normally closed clutch. In the closed positioned, the engine 12 is coupled to the transmission 14 so as to provide to torque to the transmission 14. The manual transmission 14 is a multi-speed transmission including a plurality of gear sets providing a range of gear ratios for both forward speeds and at least one reverse speed. The gear sets are indicated generally with reference number 15 and the actuators, typically in the form of synchronizers, are indicated generally with reference number 16 in FIG. 1.

The system 10 for operating the powertrain 11 for protection of the clutch 13 further includes an engine control unit 17 and a sensor 18 for sensing the position of a throttle 19 of the engine 12. The throttle 19 is coupled to the acceleration pedal 20 of the vehicle which is depressed by the driver of the vehicle to accelerate the vehicle. The acceleration pedal 20 may adjust the position of the throttle 19, directly, as indicated by arrow 21, or may send a signal 22 to the engine control unit 17 which then controls the position of the throttle 19 corresponding to the signal 22.

The engine control unit 17 comprises computer executable code for estimating the drive resistance of the vehicle and for predicting the available engine torque that can be delivered for the sensed position of the throttle 19. The engine control unit 17 further comprises computer executable code for predicting the thermal loading on the clutch 13 using the estimated drive resistance of the vehicle and the predicted available engine torque and for comparing this estimated thermal load on the clutch 13 with a predetermined threshold. The predetermined threshold may represent a maximum allowable thermal load before wear or damage to the clutch 13 occurs.

The engine control unit 17 is constructed so that it is able to override the position of the throttle 19 corresponding to the command of the driver and increase the torque delivered by the engine 12 above the predicted available torque deliverable by the engine 12 at the sensed position of the throttle 19 as indicated by arrow 23.

In order to provide clutch protection, the system 10 may be operated as follows: the drive resistance of the vehicle is estimated and the position of the throttle 19 of the engine 12 is sensed using sensor 18. This position of the throttle 19 is set by the driver depressing acceleration pedal 20. The available engine torque deliverable by the engine 12 at this sensed position of the throttle 19 is estimated.

The estimated drive resistance of the vehicle and the predicted available torque deliverable by the engine 12 at the sensed position of the throttle 19 are used to estimate the thermal load on the clutch 13 using a thermal model. The estimated thermal load on the clutch 13 is compared to a predetermined threshold. If the estimated thermal load on the clutch 13 is lower than the predetermined threshold, the system 10 allows the vehicle to launch with the torque determined by the position of the throttle 19, i.e., the torque commanded by the driver. If, however, the estimated thermal load on the clutch 13 is higher than the predetermined threshold, the engine control unit 17 increases the torque delivered by the engine 12 above the value of the estimated torque at the sensed position of the throttle 19 and overrides the drivers command. By increasing the torque delivered to the clutch 13, the clutch slip can be reduced, thus reducing thermal load upon the clutch 13 upon launch of the vehicle. The system 10 then allows the vehicle to launch using this increased value of torque.

If the engine control unit 17 increases the torque delivered by the engine 12 above the value of the estimated torque at the sensed position of the throttle 19 and, therefore, above the value of the torque requested by the driver pressing the accelerator pedal 20, a driver warning in the form of a light 26 on the instrument panel of the vehicle can be actuated to warn the driver that the engine control unit 17 has overridden the command and increased the torque.

The above methods of operating the powertrain 11 may be used to ensure that the thermal load on the clutch 13 upon launch of the vehicle is below the predetermined threshold. The method may be carried out if a launch condition of the vehicle is determined. The engine control unit 17 can determine whether the launch of the vehicle is likely by sensing vehicle parameters such as the engagement of first gear or a reverse gear, indicated by sensor 24, a zero vehicle speed from sensor 25 indicating that the vehicle is stationary, an open clutch and a request to open the throttle 19 by the driver depressing the acceleration pedal 20 which sends signal 22 to the engine control unit 17.

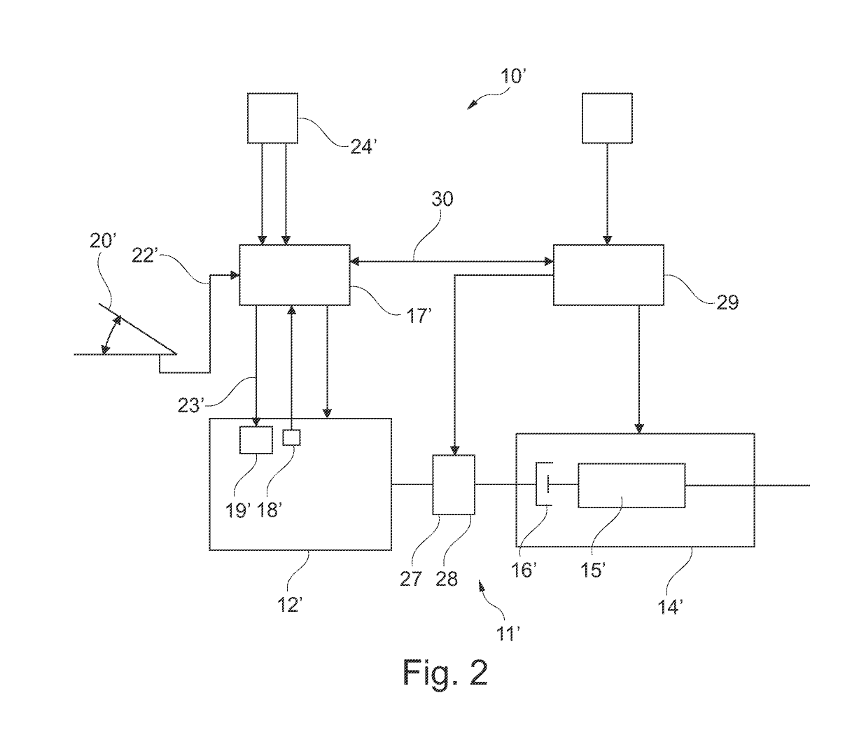

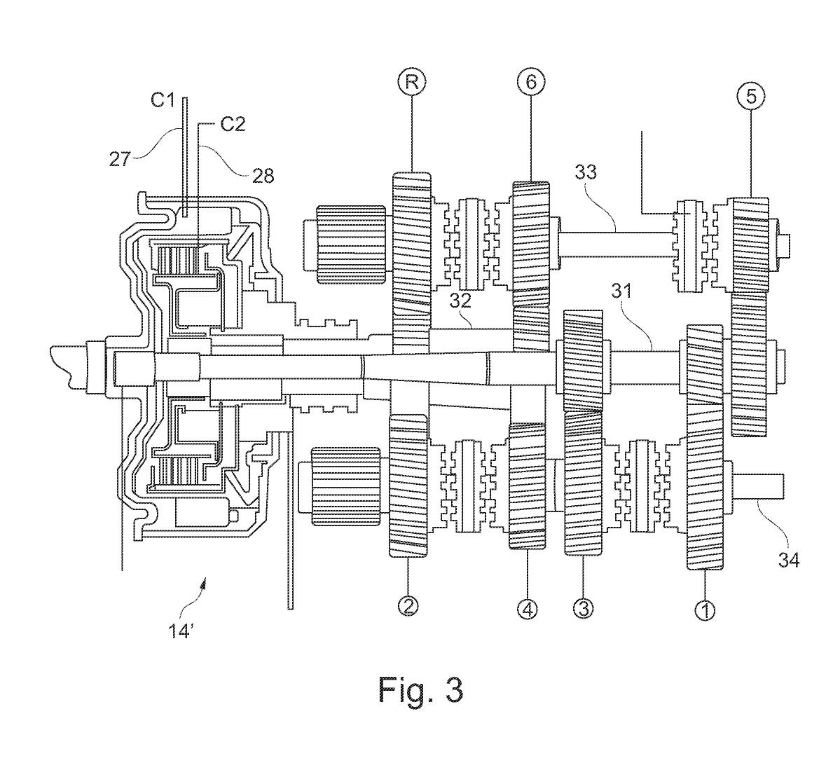

FIG. 2 illustrates a schematic diagram of a system 10′ for operating a powertrain 11′ of a non-illustrated vehicle with an internal combustion engine 12′ and a dual clutch transmission 14′. FIG. 3 illustrates the dual clutch transmission 14′ in more detail. The system 10′ for operating the powertrain 11′ for protection of the dual clutches 27, 28 further includes an engine control unit 17′, a sensor 18′ for sensing the position of a throttle 19′ of the engine 12′ and a transmission control unit 29 for controlling the transmission and actuation of the two dry cluches 26, 27.

The throttle 19′ is coupled to the acceleration pedal 20′ of the vehicle which is depressed by the driver of the vehicle in order to launch and accelerate the vehicle. As in the first embodiment, depressing the acceleration pedal 20′ sends a signal 22′ to the engine control unit 17′ which then controls the position of the throttle 19′ corresponding to the signal 22′.

Computer executable code used by the system 10′ to provide clutch protection is stored and executed by the engine control unit 17′ and the transmission control unit 29.

The engine control unit 17′ comprises computer executable code for predicting the available engine torque that can be delivered for the sensed position of the throttle 19′. The engine control unit 17′ is also able to increase the torque delivered by the engine 12′ above the predicted available torque deliverable by the engine 12′ at the sensed position of the throttle 19′ as indicated by arrow 23′.

The transmission control unit 29 comprises computer executable code for estimating the drive resistance of the vehicle and for predicting the thermal loading on the clutches 27, 28 using the estimated drive resistance of the vehicle and the predicted available engine torque, sent to it by the engine control unit 17′, as indicated by arrow 30, and for comparing this estimated thermal load on the clutches 27, 28 with a predetermined threshold.

FIG. 3 illustrates the dual clutch transmission system 14′ which comprises two dry normally-open clutches 27, 28, six forward gears and one reverse gear. However, the system 10′ for operating a powertrain 11′ may be used with any dual clutch transmission and is not limited to the dual clutch transmission illustrated in FIG. 3.

The dual clutch multi-speed transmission 14′ comprises a first input shaft 31 in the form of a solid rod and a second input shaft 32 in the form of a hollow rod which is arranged concentrically around the first input shaft 31 and two countershafts 33, 34 radially spaced from the input shafts 31, 32. The first input shaft 31 is coupled to, and driven by, the engine 12′ by closing the first clutch 27 whilst the second clutch 28 is open. The second input shaft 32 coupled to, and driven by, the engine 12′ by closing the second clutch 28 and opening the first clutch 27. Gear sets providing the odd gears of the multi-speed transmission are driven by the first input shaft 31 and, therefore, by closing the first clutch 27. Gear sets providing the even gears and reverse gear are driven by the second input shaft 32 and closing the second clutch 28. The vehicle may be launched in either first gear or in reverse gear by coupling the first clutch 27 or the second clutch 28 to the first input shaft 31 or second input shaft 32, respectively. Therefore, the system 10′ can be used to protect both of the clutches 27, 28.

In order to provide clutch protection, the system 10′ may be operated as follows. The drive resistance of the vehicle is estimated by the transmission control unit 29. The position of the throttle 19′ is set by the driver depressing acceleration pedal 20′ and the position of the throttle 19′ of the engine 12′ is sensed using sensor 18′ by the engine control unit 17′. The available engine torque deliverable by the engine 12′ at this sensed position of the throttle 19′ is estimated by the engine control unit 17′ and this information is sent to the transmission control unit 29.

The transmission control unit 29 uses the estimated drive resistance of the vehicle and the predicted available torque deliverable by the engine 12′ at the sensed position of the throttle 19′ to estimate the thermal load on the clutch 27 using a thermal model and compares the estimated thermal load to a predetermined threshold. If the estimated thermal load on the clutch 27 is lower than the predetermined threshold, the system 10′ allows the vehicle to launch with the torque determined by the position of the throttle 19′ as commanded by the driver. If, however, the estimated thermal load on the clutch 27 is higher than the predetermined threshold, the engine control unit 17′ increases the torque delivered by the engine 12′ above the value of the estimated torque at the sensed position of the throttle 19′ thus overriding the drivers command. By increasing the torque delivered to the clutch 27, the clutch slip can be reduced, thus reducing thermal load upon the clutch 27 upon launch of the vehicle. The system 10′ then allows the vehicle to launch using this increased value of torque.

As in the first embodiment, if the engine control unit 17′ increases the torque delivered by the engine 12′ above the value of the estimated torque at the sense position of the throttle 19′ and, therefore, above the value of the torque requested by the driver pressing the accelerator pedal 20′, a driver warning in the form of a light 26 or in the instrument panel of the vehicle can be actuated to warn the driver that the engine control unit 17 has overridden the command and increased the torque.

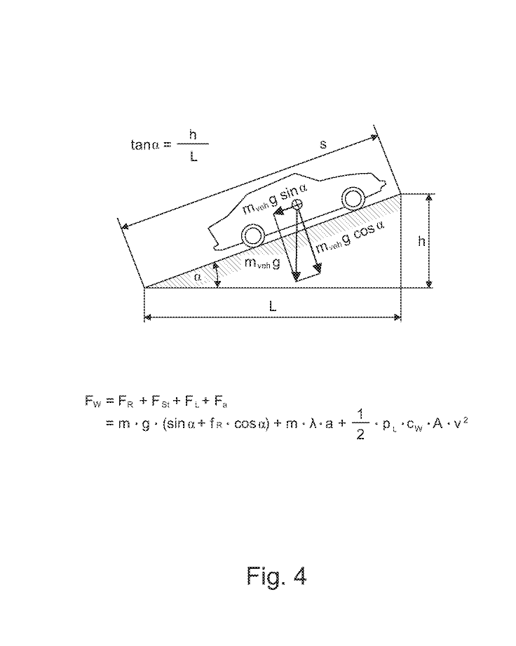

FIG. 4 illustrates a method to provide an estimation of the drive resistance of a vehicle. The total drive resistance of a motor vehicle, F_{w}, may be considered to comprise four parts, rolling resistance, F_{R}, gradient resistance, F_{ST}, air resistance, F_{L}, and acceleration resistance F_{A}, whereby m is the vehicle mass, g acceleration due to gravity, α is inclination, f_{R} is a tyre friction constant, λ is rotational inertia of the engine drive shaft, ρ₁ is air density, c_{w} is air drag coefficient, A is cross-sectional area and v is velocity.

When launching the vehicle, the air resistance may be neglected. The static drive resistance increases rapidly with combined vehicle mass and inclined slopes so that less torque can be used to accelerate the vehicle. When correlating engine torque with static drive resistance, and in particular the rolling resistance, gradient resistance and acceleration resistance, the achievable acceleration decreases. This in turn means that the time required to synchronise the rotating engine and rolling vehicle increases and the clutch slip time increases. When the slip time increases, the thermal load to the launch device increases, whereby the launch device provides the infinite ratio between the rotating engine and resting vehicle. The drive resistance and available fraction should be balanced, also during launch. If the available fraction exceeds the road resistance, acceleration is possible.

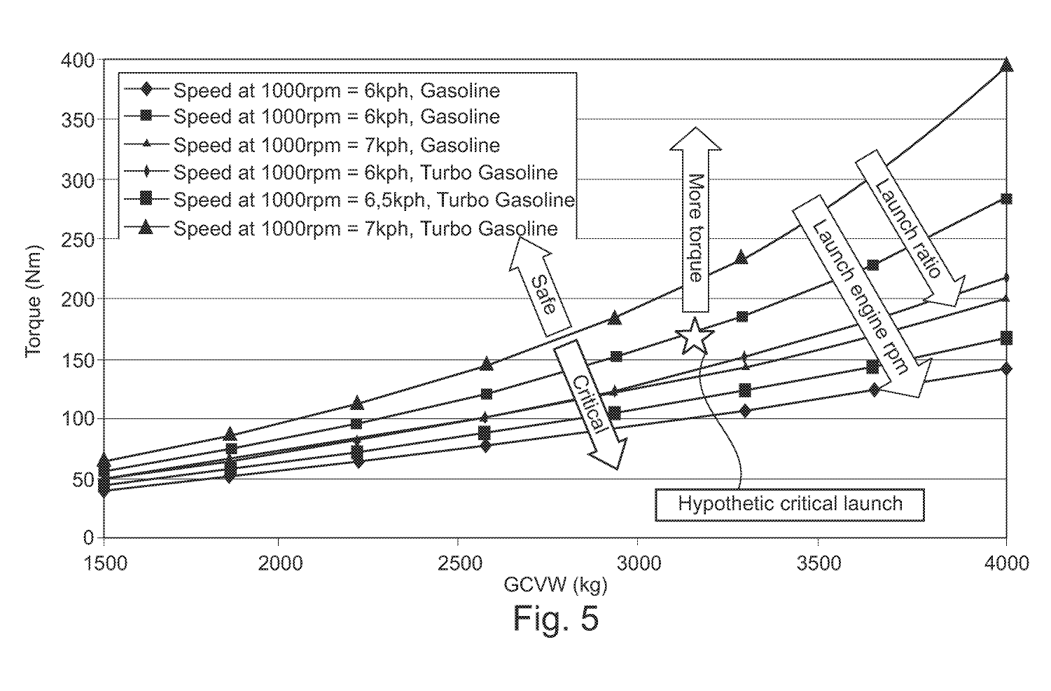

FIG. 5 illustrates a graph of torque against combined gross vehicle weight (CGVW) and represents a clutch thermal capacity diagram. The solid and dashed lines illustrate the required engine torque against gross combined vehicle weight for naturally aspirated and turbocharged gasoline engines, respectively. A similar trend is observed for diesel engines.

If an engine torque-GCVW combination is selected for a transmission with the given vehicle speed at 1000 rpm (which is directly determined by the launch ratio of transmission) is located below the corresponding line, the clutch will fail due to thermal overload since the slip time in critical conditions is too long and too much damaging heat is generated in the clutch lining. Increasing the engine torque for a given GCVW, reduces slip time during launch and reduces the thermal load on the clutch. The higher the launch ratio, the less engine torque is required for a given GCVW to produce thermal load on the clutch and provide a more robust clutch system.

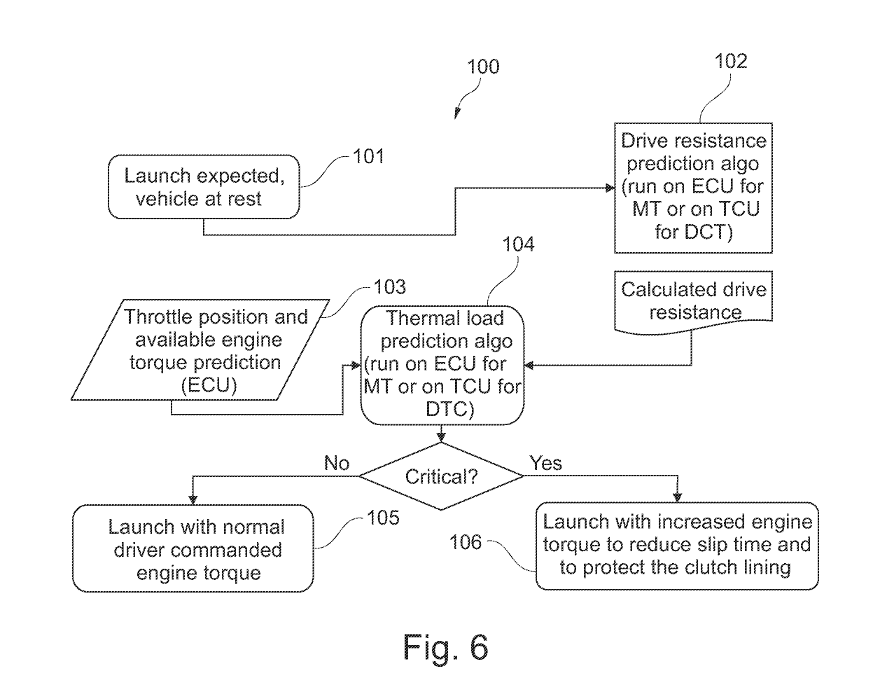

A method of operating a powertrain for protection of a clutch is illustrated in the form of a flow diagram 100 in FIG. 6. In step 101, it is determined that the vehicle is at rest and that launch of the vehicle is expected. In step 102, a drive resistance prediction algorithm is run and the drive resistance is calculated. In step 103 the position of the throttle 19 is sensed and the available engine torque at this throttle position is predicted. In step 104 the value of the predicted available engine torque at the sensed throttle position and the value of the calculated drive resistance are used in a thermal loading prediction algorithm to predict the thermal load on the clutch.

If the value of the estimated thermal load on the clutch 13 is less than a predetermined threshold, the method proceeds to step 106 and the vehicle is launched with the engine torque commanded by the driver that is with the torque delivered by the engine at the sensed throttle position. If the value of the estimated thermal load on the clutch 13 is greater than the predetermined threshold, the method proceeds to step 106 and the engine torque delivered to the clutch 13 is increased above the value of the engine torque deliverable at the sensed throttle position in order to reduce the clutch slip time, reduce the thermal load on the clutch due to slip and protect the clutch lining.

This method may be used for a powertrain with a manual transmission or a dual clutch transmission. If the powertrain has a manual transmission, steps 102, 103 and 104 may be performed by the engine control unit. If the powertrain has a dual clutch transmission and a transmission control unit in addition to an engine control unit, steps 102 and 104 may be performed by the transmission control unit and step 103 may be performed by the engine control unit.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method of operating a powertrain of a vehicle, the powertrain comprising a prime drive that is coupleable to a multi-speed transmission by actuation of a clutch, the method comprising:
estimating a drive resistance of the vehicle;
sensing a position of a throttle of the prime drive;
estimating a torque that is deliverable by the prime drive at the position of the throttle);
estimating a thermal load on the clutch using the drive resistance of the vehicle and the torque that is deliverable by the prime drive;
comparing the thermal load on the clutch with a predetermined threshold;
allowing the vehicle to launch if the thermal load on the clutch is lower than the predetermined threshold; and
increasing the torque delivered by the prime drive above the torque at the position of the throttle to reduce the thermal load on the clutch upon launch of the vehicle and afterwards allowing the vehicle to launch if the thermal load on the clutch is higher than the predetermined threshold.

2. The method according to claim 1, wherein the torque delivered by the prime drive is increased by an amount sufficient that the thermal load on the clutch is reduced to below the predetermined threshold.

3. The method according to claim 1, further comprising actuating a driver warning if the torque delivered by the prime drive is increased above the torque at the position of the throttle.

4. The method according to claim 1, further comprising increasing the torque at the position of the throttle by further opening the throttle.

5. The method according to claim 1, wherein estimating the drive resistance of the vehicle comprises using a parameter comprising at least one of combined gross vehicle weight, rolling resistance, gradient resistance, air resistance or acceleration resistance.

6. The method according to claim 1, wherein estimating the thermal load on the clutch comprises using a parameters comprising at least one of a convection, thermal mass of the clutch, an estimated clutch slip or a gear ratio.

7. The method according to claim 1, wherein estimating the thermal load on the clutch comprising taking into account the thermal load on the clutch within a predetermined previous time interval.

8. The method according to claim 1, further comprising determining a total torque to be delivered to the clutch and an expected clutch slip time interval for the total torque and adjusting the clutch to decrease a clutch slip time compared to the expected clutch slip time interval.

9. A powertrain of a vehicle, comprising:
a prime drive that is coupleable to a multi-speed transmission by actuation of a clutch (13; 27, 28; and
a system for operating the powertrain for protection of the clutch, the system comprising:
a first estimator configured to estimate a drive resistance of the vehicle;
a first sensor configured to sense a position of a throttle of the prime drive;
a second estimator configured to estimate a torque that is deliverable by the prime drive at the position of the throttle;
a third estimator configured to estimate a thermal load on the clutch from the drive resistance of the vehicle and the torque that is deliverable by the prime drive at the position of the throttle;
a comparator configured to compare the thermal load on the clutch with a predetermined threshold; and
an apparatus configured to increase the torque delivered by the prime drive above the torque at the position of the throttle to reduce the thermal load on the clutch upon launch of the vehicle if the thermal load on the clutch is higher than the predetermined threshold.

10. The powertrain according to claim 9, wherein the multi-speed transmission is a manual transmission or a dual clutch transmission.

11. The powertrain according to claim 9, wherein the multi-speed transmission is a dual clutch transmission.

12. A computer readable medium embodying a computer program product, said computer program product comprising:
a powertrain operating program, the program configured to operate a powertrain of a vehicle, the powertrain comprising a prime drive that is coupleable to a multi-speed transmission by actuation of a clutch, the program configured to:
estimate a drive resistance of the vehicle;
sense a position of a throttle of the prime drive;
estimate a torque that is deliverable by the prime drive at the position of the throttle;
estimate a thermal load on the clutch using the drive resistance of the vehicle and the torque that is deliverable by the prime drive;
compare the thermal load on the clutch with a predetermined threshold;
allow the vehicle to launch if the thermal load on the clutch is lower than the predetermined threshold; and
increase the torque delivered by the prime drive above the torque at the position of the throttle to reduce the thermal load on the clutch upon launch of the vehicle and afterwards allowing the vehicle to launch if the thermal load on the clutch is higher than the predetermined threshold.

13. The computer readable medium embodying the computer program product according to claim 12, the program further configured to increase the torque delivered by the prime drive by an amount sufficient that the thermal load on the clutch is reduced to below the predetermined threshold.

14. The computer readable medium embodying the computer program product according to claim 12, the program further configured to actuate a driver warning if the torque delivered by the prime drive is increased above the torque at the position of the throttle.

15. The computer readable medium embodying the computer program product according to claim 12, the program further configured to increase the torque at the position of the throttle by further opening the throttle.

16. The computer readable medium embodying the computer program product according to claim 12, wherein the estimate of the drive resistance of the vehicle comprises using a parameter comprising at least one of combined gross vehicle weight, rolling resistance, gradient resistance, air resistance or acceleration resistance.

17. The computer readable medium embodying the computer program product according to claim 12, wherein the estimate of the thermal load on the clutch comprises using a parameters comprising at least one of a convection, thermal mass of the clutch, an estimated clutch slip or a gear ratio.

18. The computer readable medium embodying the computer program product according to claim 12, the program further configured to determine a total torque to be delivered to the clutch and an expected clutch slip time interval for the total torque and adjusting the clutch to decrease a clutch slip time compared to the expected clutch slip time interval.
